(19) United States
(12) Patent Application Publication
(10) Pub. No.: US 2012/0269561 A1
(43) Pub. Date: Oct. 25, 2012

(54) IMAGE FORMING APPARATUS

(75) Inventor: Haruhiko Omata, Abiko-shi (JP)

(73) Assignee: CANON KABUSHIKI KAISHA, Tokyo (JP)

(21) Appl. No.: 13/451,029

(22) Filed: Apr. 19, 2012

(30) Foreign Application Priority Data
Apr. 20, 2011 (JP) 2011-093900

(51) Int. Cl. G03G 15/20

(52) U.S. Cl. 399/335

(57) ABSTRACT

An image forming apparatus includes a non-transparent image forming device for forming a non-transparent toner image on a sheet; a transparent image forming device for forming a transparent toner image on a sheet; a partial heating device for heating an area, designated by a user, of the sheet having a toner image; and a control device for controlling the transparent image forming device such that the transparent toner is overlaid on an area where an amount, per unit area, of the non-transparent toner image formed in the area designated by the user is 0 or less than a predetermined amount.

### FIELD OF THE INVENTION AND RELATED ART

The present invention relates to an image forming apparatus comprising a partial heating device for selectively heating a part of a sheet.

Recently, an apparatus in which a non-transparent toner image and a partial transparent toner image are formed to selectively adjust the glossinesses has been put into practice. More particularly, the transparent toner is fixed on a part of the sheet, thus providing a glossiness difference between an area having the transparent toner and an area not having a transparent toner so that a mark which is visible by the glossiness difference is formed.

However, even if an attempt is made to express the glossiness difference by partly forming the transparent toner, the expressed glossiness difference on the sheet is small when the transparent toner is fixed by a fixing means such as a fixing roller which uniformly heats the whole surface of the recording material. Particularly, no remarkable glossiness difference can be provided when the transparent toner is partly overlaid on a photographic image using a large amount of the non-transparent toner. This is because in such a case, the glossiness difference between the portion having the non-transparent toner only and the portion having both of the non-transparent toner and the transparent toner thereon when the images are fixed by such a fixing device.

On the other hand, Japanese Laid-open Patent Application 2004-170548 discloses a structure in which a special film provided with a heat fusible layer is put on the surface of the sheet, and the special film is locally heated by a thermal head. In this case, the surface property of the portion heated by the thermal head becomes the same as the surface property of the film. Therefore, the surface property can be differentiated.

However, the necessity of using the special film leads to cost increase Use of plain paper does not provide the surface property difference.

### SUMMARY OF THE INVENTION

In view of the foregoing, the prevent invention provides an image forming apparatus comprising a non-transparent image forming device for forming a non-transparent toner image on a sheet; a transparent image forming device for forming a transparent toner image on a sheet; a partial heating device for heating an area, designated by a user, of the sheet having a toner image; and a control device for controlling said transparent image forming device such that the transparent toner is overlaid on an area where an amount, per unit area, of the non-transparent toner image formed in the area designated by the user is 0 or less than a predetermined amount.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of the structures of an image forming apparatus.

FIG. 2 is an illustration of the structures of an image forming station.

FIG. 3 is a block diagram of a control system of the image forming apparatus.

FIG. 4 is a top plan view of an operation display screen portion.

FIG. 5 is an illustration of the structures of a fixing device.

FIG. 6 is an illustration of the structures of a glossiness treating device.

FIG. 7 shows a relation between an amount of toner and a glossiness after glossiness treatment.

FIG. 8 is a flow chart of a glossiness treatment control according to Embodiment 1.

FIG. 9 is a flow chart of transparent toner amount control.

FIG. 10 is an illustration of transparent toner amount setting.

FIG. 11 is an illustration of the structures of a full-color image forming device according to Embodiment 2.

FIG. 12 is an illustration of the structures of a transparent image forming device.

FIG. 13 is an illustration of the structures of a glossiness treating device.

FIG. 14 is an illustration of the structures of an image surface treatment device according to Embodiment 3.

### DESCRIPTION OF THE PREFERRED EMBODIMENTS

Referring to and accompanying drawings, embodiments of the present invention will be described in detail. However, the present invention is not restricted to the specific structures which will be described.

For example, the present invention is applicable to a monochromatic full-color image forming apparatus of a recording material feeding type/an intermediary transfer type, a one component developer type, a two component developer type, a tandem type or one drum type, irrespective of the charging type, exposure type, transfer type or the like.

With respect to this embodiment the description will be made as to the major part of the formation and the transfer, but the present invention is combined with various equipment, casing and the like to provide a printer, an image forming apparatus such as a copying machine, a facsimile machine, a complex machine.

As to ordinary known structures and functions disclosed in Japanese Laid-open Patent Applications 2009-251058, 2007-086747 and 2004-170548, the description is omitted for the sake of simplicity.

### <Image Forming Apparatus>

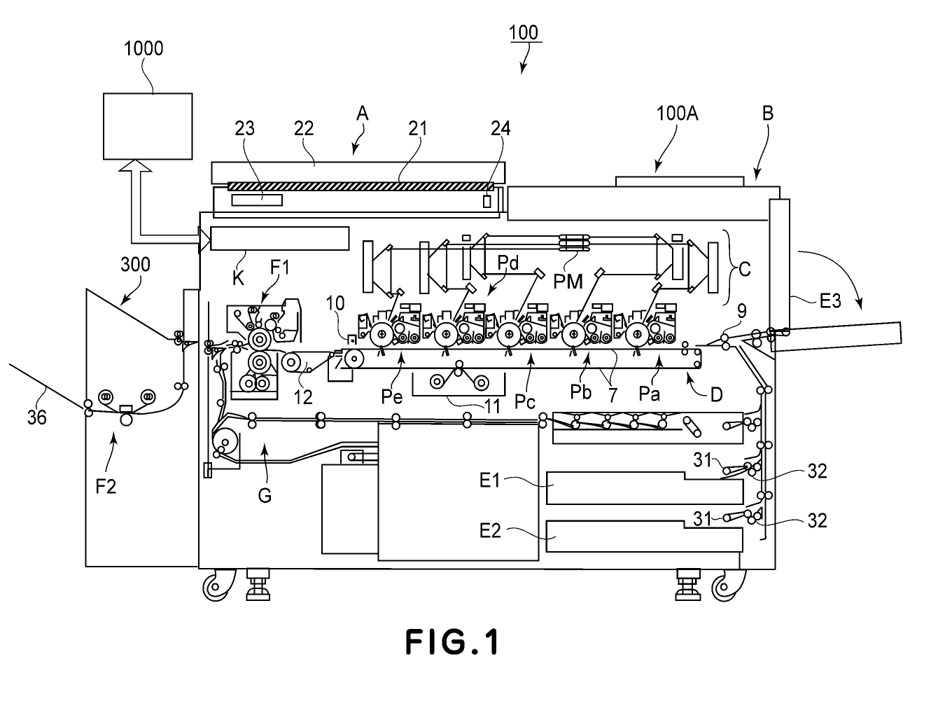

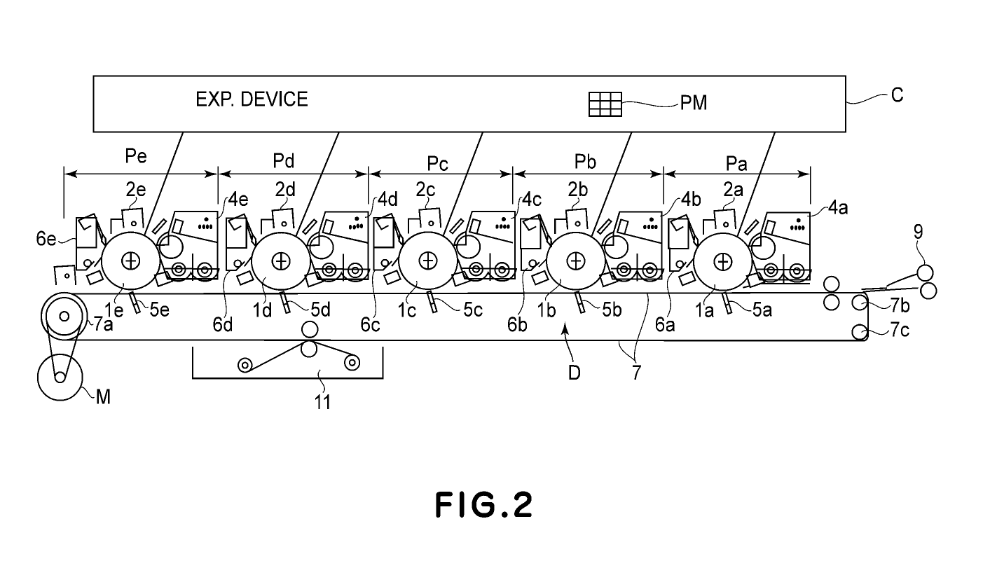

FIG. 1 is an illustration of the structures of an image forming apparatus. FIG. 2 is an illustration of the structures of an image forming station. As shown in FIG. 1, the image forming apparatus 100 is a tandem type recording material feeding type full color printer in which image forming stations Pa, Pb, Pc, Pd, Pe for yellow, magenta, cyan, black, clear toner particles are arranged along the recording material feeding belt 7.

A recording material P is picked up by a pick-up roller 31 from a first recording material cassette E1 or a second recording material cassette E2 and is singled out by a separation roller 32 and is fed to registration rollers 9. The registration roller 9 feeds the recording material P out to a recording material feeding belt 7 in timed relation with the toner image formed by the image forming stations Pa, Pb, Pc, Pd, Pe.

In the image forming station Pa which is a non-transparent image forming station, a yellow toner image is formed and is transferred onto the recording material P carried on the recording material feeding belt 7. By the transfer of the image, the recording material P is held on the recording material feeding belt 7 firmly by an electrostatic attraction force, and is fed to the transfer portions of the image forming stations Pb, Pc, Pd, Pe sequentially. In the image forming station Pb, a magenta toner image is formed and is transferred onto the recording material P carried on the recording material feeding belt 7. Similarly, in the image forming stations Pc and Pd, a cyan toner image and a black toner image are formed on the respective photosensitive drums 1c and Pd and are transferred onto the recording material P carried on the recording material feeding belt 7.

In the image forming station Pe which is a transparent image forming station, a clear toner image is formed on the photosensitive drum 1e and is transferred onto the recording material P carried on the recording material feeding belt 7. By sequentially transferring the respective color toner images formed by the image forming stations Pb, Pc, Pd, Pe onto the recording material P, a four full-color toner image (unfixed) and a transparent toner image (unfixed) are formed synthetically.

A separation charger 10 discharges the recording material P to weaken the attraction to the recording material feeding belt 7. The recording material P is separated from the recording material feeding belt 7 by curvature change and is introduced by a feeding belt 12 to a fixing device F1 for fixing the toner image on the recording material. The fixing device F1 is a heat roller fixing device as will be described hereinafter. The recording material P carrying the four color toner images and the clear toner image is subjected to the heat pressing by the fixing device F so that the toner image is fixed on the recording material P, and then the recording material P is fed into a glossiness treating device 300. The glossiness treating device 300 heats an area-to-be-heated on the recording material having set configuration and area to provide specular image surface.

The image forming stations Pa, Pb, Pc, Pd, Pe have substantially the same structure except for the toner colors contained in developing devices 4a, 4b, 4c, 4d, 4e. In the following, referring to FIG. 2, the structure and the operation of the image forming station Pa will be described, and as for the image forming stations Pb, Pc, Pd, Pe, the descriptions are applicable if suffixes at the end of the reference characters are replaced with b, c, d, e.

As shown in FIG. 2, the image forming station Pa includes, around the photosensitive drum 1a, a corona charger 2a, an exposure device C, a developing device 4a, a transfer charger 5a and a drum cleaning device 6a.

The photosensitive drum 1a has an aluminum cylinder and a photosensitive layer on the outer surface of the aluminum cylinder, the photosensitive layer having a negative charge polarity, and the photosensitive drum 1a is rotatable in the direction indicated by the arrow at a predetermined process speed. The corona charger 2a charges uniformly the surface of the photosensitive drum 1a to a negative dark portion potential VD.

Simultaneously with the recording material P being fed to the transfer portion of the image forming station Pa, the image writing signal is rendered ON, on the basis of which the image formation is executed on the photosensitive drum 1a of the image forming station Pa at the predetermined control timing.

As shown in FIG. 1, the exposure devices C is a laser scanning mechanism (laser scanner) provided above image forming stations Pa, Pb, Pc, Pd, Pe and having a plurality of optical scanning means. The exposure device C exposes the surface of the photosensitive drum 1a with the scanning laser beam which is modulated in accordance with the image signal to form an electrostatic image on the surface of the photosensitive drums 1a in accordance with the image signal. In the exposure device C, a polygonal mirror PM is rotated to deflect the laser beam emitted from the laser source, and the scanning laser beam is deflected by a reflection mirror and then is focussed on the photosensitive drum 1a by a fθ lens to scan the photosensitive drum 1a along the generatrix thereof. By this, the electrostatic image is formed on the photosensitive drum 1a in accordance with the image signal.

In the developing device 4a, a two component developer containing toner and carrier in mixture is stirred by which the toner is charged. The photosensitive drum 1a is rubbed with a magnetic brush of the charged developer to develop the electrostatic image to provide a toner image on the surface of the photosensitive drum 1a.

In a transfer portion below the photosensitive drum 1a, a transfer charger 5a applies an electric field or a charge so that the yellow toner image formed on the photosensitive drum 1a is transferred onto the recording material P. The transfer charger 5a presses the inner side surface of the recording material feeding belt 7 to establish a transfer portion between the photosensitive drum 1a and the recording material P on the recording material feeding member. A drum cleaning device 6a collects untransferred toner remaining on the photosensitive drum 1a.

### <Partial Glossiness Treatment>

In the field of offset printing, a partial glossiness treatment is used to improve the value of the prints. Here, the target glossiness is 80-100%) (60° in specular surface glossiness (specular surface glossiness measuring method stipulated in JISZ8741), which means so specular that a light is clearly reflected by the print.

Such a high glossiness surface is used on a part of the print for a corporate logo or a brand logo for example to make it conspicuous.

In the offset printing technique, the glossiness of the printing ink provides glossiness 30-50%(60°), and therefore, in order to provide the glossiness 80-100%(60°), the use is ordinarily made with transparent ink of the ultraviolet radiation curing type, and the transparent ink is cured by ultraviolet radiation after printing.

On the other hand, in the image forming apparatus of the electrophotographic type in which the toner image is heat fixed on the recording material, a proposal has been made in which the partial glossiness treatment of high quality can be accomplished. In an ordinary electrophotographic system, the glossiness of the output image is as low as 10-50%(60°), and therefore, the toner image is fixed and then the image is subjected to a so-called post-processing device which is a glossiness treating device to provide the glossiness of 80-100%)(60°.

Japanese Laid-open Patent Application 2004-170548 (Japanese Laid-open Patent Application 2004-170548) discloses a recording material including a thermoplastic resin layer. In the state that the image surface is press-contacted to the fixing belt having a high glossiness surface, the thermoplastic resin layer is heated through an endless belt using a thermal head up to a level not less than the softening point temperature so that the thermoplastic resin layer is stuck on the endless belt. Then, the recording material is cooled while being closely contacted to the fixing belt to cure the thermoplastic resin layer, and then the recording material is peeled off the fixing belt. By doing so, the surface of the toner image becomes analogous to the surface of the fixing belt and therefore becomes very smooth so that high glossiness property color image can be provided.

Although Japanese Laid-open Patent Application 2004-170548 does not directly discloses, when the use is made with thermal head, a partial glossiness treatment can be accomplished for any characters or patents with proper resolution. When, on the other hand, the use is made with a pair of heat rollers as disclosed in Japanese Laid-open Patent Application 2007-086747 (Japanese Laid-open Patent Application 2007-086747), the image surface is uniformly heated, and therefore, partial glossiness treatment is difficult.

Returning to Japanese Laid-open Patent Application, however, the glossiness remains the same when the electrophotographic sheet, plain paper, printing sheet having a surface which does not melt at the temperature around the fixing temperature. If the color toner image is carried on the area which is desired to be specular, the area can be made specular, but the background area not having the toner image cannot be made specular.

For this reason, Japanese Laid-open Patent Application 2004-170548 uses the recording material having the thermoplastic resin surface layer. However, such a recording material is not ordinary, is hardly available on the market with the result of increase of the cost for the recording materials.

It is desirable to provide an image forming apparatus capable of producing the image having the high glossiness even using a recording material having a surface which is not used at the temperature around the fixing temperature. A representative structure for achieving this comprises an image forming station for forming the toner image, and a glossiness treating device with which the heating area is variable. With such a structure, the recording material entirely covered by the fixed toner image is selectively heated by the glossiness treating device with which an area-to-be-heated having a shape and area on the basis of glossiness treatment data indicating an area to be subjected to the glossiness treatment.

### <Toner>

The toner used is polyester resin material toner. In this embodiment, the toner is produced by a pulverization method. As for the method of producing the toner, a suspension polymerization method, an interface polymerization method, a dispersion polymerization method or the like in which the toner is produced directly in medium are preferable. However, the component of the toner and the manufacturing method thereof not limited to these examples.

As for the manufacturing method of the transparent toner, the same polyester resin material is used without using color pigment. The glass transition point (Tg) is not restrictive particularly.

The transparent toner is not necessarily transparent in the powder state thereof. For example, the transparent toner used here is white in the unfixed state. The toner particles having a particle size of 5-10 μm are white because most of the light is scattered by the surface of the toner particles.

In other words, the transparent toner is whity when the energy applied thereto by the fixing operation is small. Even in such a state, the quality is satisfactory when the glossiness is target value and the transparent toner is not peeled off.

### <Control System of Image Forming Apparatus>

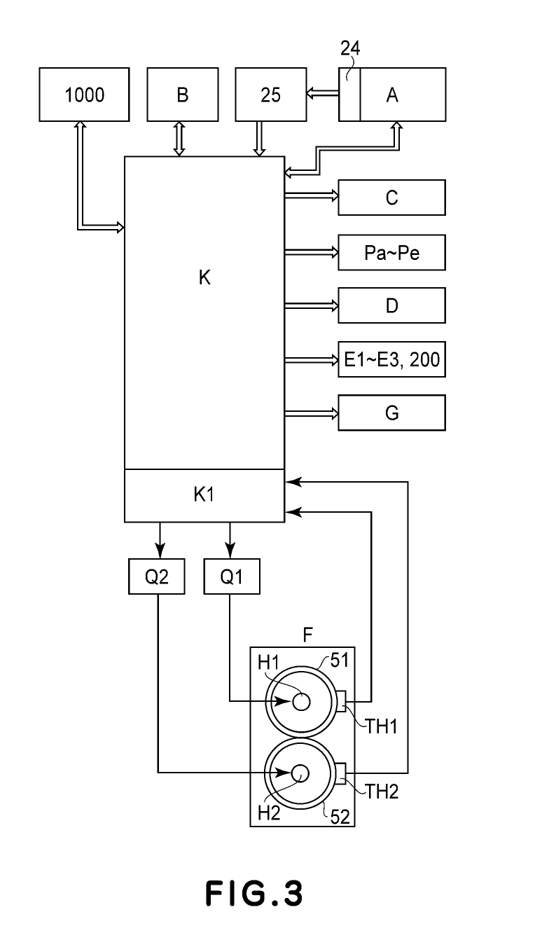

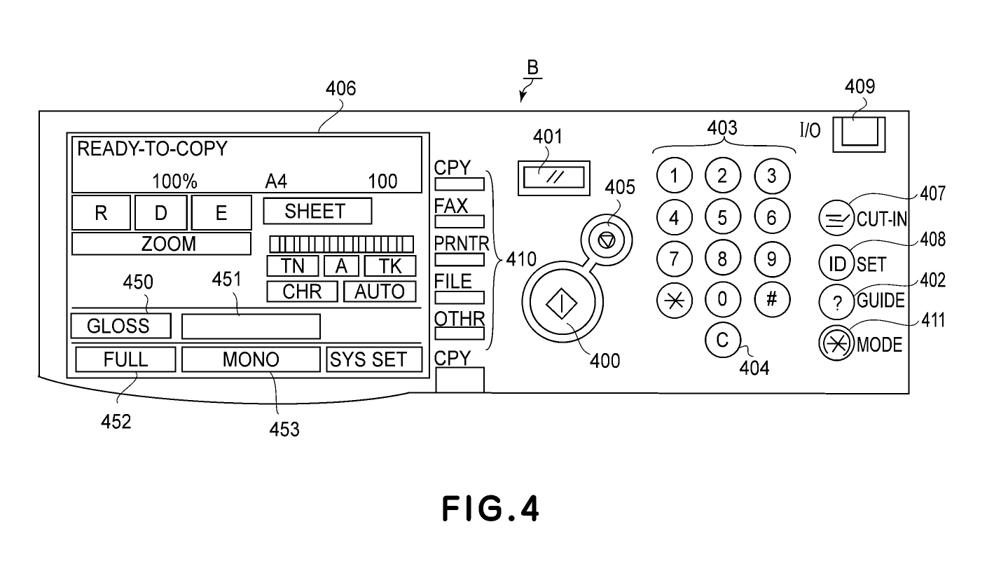

FIG. 3 is a block diagram of a control system of the image forming apparatus. FIG. 4 is a top plan view of an operation display screen portion.

As shown in FIG. 1, an original reading station (image scanner) An and an operation display screen portion B are provided at a top side. In the original reading station A, an original covering plate 22 can be opened and closed relative to an original supporting platen glass 21. The original covering plate 22 may be provided with an original automatic feeding device (ADF, RDF) by which original sheets can be automatically fed. A transfer belt mechanism D is provided below the image forming stations Pa, Pb, Pc, Pd, Pe. The fixing device F1 is provided downstream of the transfer belt mechanism D with respect to the feeding direction of the recording material.

A first recording material cassette (cassette sheet feeder) E1 and a second recording material cassette E2 are disposed below the transfer belt mechanism D in a two-stage arrangement. A manual insertion sheet feeding tray E3 can be folded on the image forming apparatus 100 and is opened when necessary. When a selected sheet feeder among the first recording material cassette E1, the second recording material cassette E2 and the manual insertion sheet feeding tray E3 is actuated, a recording material P is singled out of the sheet feeder.

Referring to FIG. 1 and FIG. 3, a controller (control circuit portion, controller substrate portion) K is a computer for overall control of the image forming apparatus 100. An external inputting device (external host apparatus) 1000 is a personal computer, a facsimile machine or the like, and is electrically connected with the controller K through the interface.

The original reading station An optically scans the original supported on the original supporting platen glass 21 to perform color-separation photoelectric reading of the original image. In the case of the copy mode (original copying), a color original (monochromatic original) is placed on the original supporting platen glass 21 with the image surface facedown and is covered by the original covering plate 22.

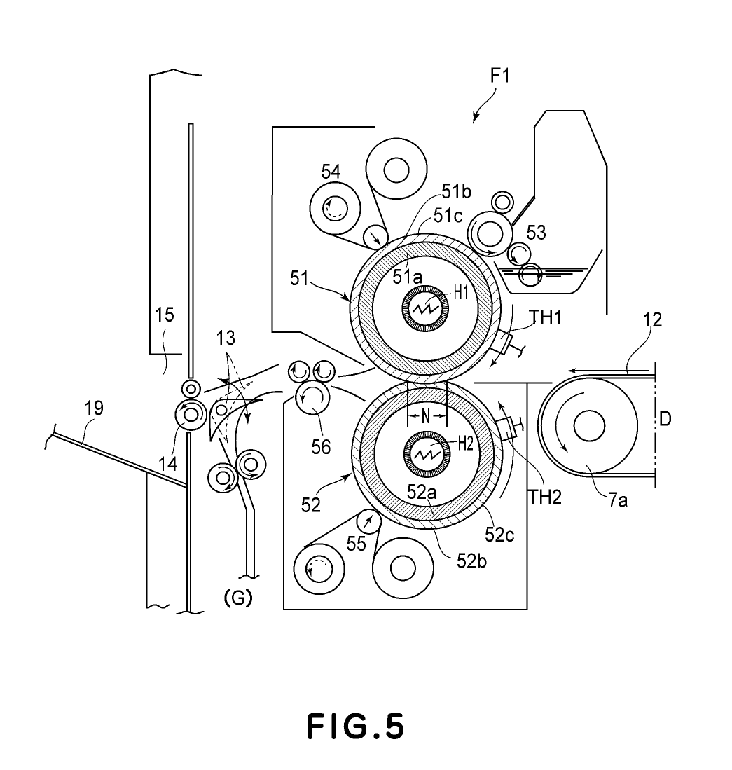

On the operation display screen portion B, the operator inputs commands and is informed of the states of apparatus. As shown in FIG. 4, the operation display screen portion B is provided with a touch panel 406 having a liquid crystal screen and various operations switches (400-409). Operator set the desired copying condition one the operation display screen portion B and then presses the copy start key 400 (FIG. 5).

As shown in FIG. 1 and FIG. 3, the moving optical system 23 is moved along a lower surface of the original supporting platen glass 21 so that the bottom surface of the original on the original supporting platen glass 21 is optically scanned. The original scanning light is image on the photoelectric conversion element (solid-state image sensing device), that is, CCD24 and is read in three primary colors RGB (red, green, blue) by the color-separation reading. The RGB signals are inputted to the image processor 25.

The image processor 25 converts the signals to C, M, Y, K electrical image information, which is inputted to the controller K. The controller K controls the exposure device C to output the laser beam modulated in accordance with the electrical image information to the image forming stations Pa, Pb, Pc, Pd, Pe.

In the case of the printer mode, the electrical image information is inputted to the controller K of the main assembly of the device 100 from the personal computer as the external inputting device 1000, so that the image forming apparatus functions as the printer. In the case of a facsimile machine reception mode, the electrical image information is inputted to the controller K of the image forming apparatus 100 from a sender facsimile machine which is the external inputting device 1000 in this case, so that the image forming apparatus 100 functions as a facsimile receiver.

The image forming apparatus 100 is capable of outputting monochromatic image prints as well as full-color prints. In the case of the monochromatic image formation, the monochromatic image formation mode is selected so that only the image forming station corresponding to the selected image forming mode among the image forming stations Pa, Pb, Pc, Pd. The other image forming stations do not perform the image forming operation although the photosensitive drum 1 is rotated. In the transfer portion of the operated image forming station, the toner image is transferred onto the recording material fed by the transfer belt mechanism D.

### <Fixing Device>

FIG. 5 is an illustration of the structures of a fixing device. As shown in FIG. 5, the fixing roller (fixing member) 51 and the pressing roller (pressing member) 52 are rotatable members rotatably supported by bearings and are juxtaposed vertically while being press-contacted to each other to form a fixing nip N therebetween. The fixing roller 51 and the pressing roller 52 are rotated by the driving motor unshown rotate in the directions indicated by the arrows in the press-contacted state.

The fixing roller 51 has a concentric three layer structure comprising a core portion 51a, an elastic layer and a parting layer 51c. The core portion 51a is a hollow pipe of aluminum having a diameter of 44 mm and a thickness of 5 mm. The elastic layer 51b is made of silicone rubber having a Jis-A hardness of 50♂o♂ and a thickness of 2.5 mm. The parting layer 51c is made of PFA having a thickness of 50 μm.

Similarly to the fixing roller 51, the pressing roller 52 has a 3 layer structure comprising a core portion 52a, an elastic layer and a parting layer. The elastic layer 52b is a silicone rubber having a thickness of 3 mm. This is because the width of the fixing nip N is increased by the elastic layer 52b, then. The pressing roller 52 is press-contacted to the fixing roller 51 at a predetermined pressure to form a fixing (heating and pressing) nip N having a predetermined width measured in the feeding direction of the recording material. The pressure of the pressing roller 52 is 294 N (30 kgf) in total pressure. At this time, the width of the fixing nip N is 7 mm.

In the hollow pipe of the core portion 51a of the fixing roller 51, there is provided a halogen lamp H1 as a heat source (roller heater). In the hollow pipe of the core portion 52a of the pressing roller 52, there is provided a halogen lamp H2 as a heat source (roller heater). The fixing roller 51 and the pressing roller 52 are heated by the halogen lamps H1, H2 from the inside, respectively. The powers of the halogen lamp H1 and the halogen lamp H2 are 800 W and 500 W, respectively.

As shown in FIG. 3, the halogen lamps H1, H2 are supplied with electric power from voltage source circuits (Q1, Q2, FIG. 3), respectively to produce heat. The surface temperatures of the fixing roller 51 and the pressing roller 52 are monitored by the temperature sensors TH1, TH2 such as a thermister contacted to them, and the electrical information relating to the detected temperatures are inputted to the fixing controller K1 of the controller K.

Fixing controller K1 controls the electric power supply to the halogen lamps H1, H2 from the voltage source circuits Q1, Q2 on the basis of the input information so that the surface temperatures (fixing temperature) of the fixing roller 51 and the pressing roller 52 are maintained at the predetermined control temperature (target temperature). The fixing controller K1 controls the temperature of the fixing nip N by controlling the temperatures of the fixing roller 51 and the pressing roller 52.

The fixing controller K1 rotates the fixing roller 51 and the pressing roller 52 and raises the surface temperatures of the rollers to the predetermined level. In such a state, the recording material P having unfixed toner image thereon is introduced into the fixing device F1 by the feeding belt 12 from the transfer belt mechanism D side.

The recording material P introduced into the fixing device F1 is nipped and fed by the fixing nip N which is the press-contact portion between the fixing roller 51 and the pressing roller 52 By this, the recording material P is heated and pressed by which the color toner images are mixed and fixed on the recording material P. The recording material P having passed through the fixing nip N is discharged by the fixing and sheet discharging rollers 56 onto the sheet discharge tray 19. The recording material P is heated and is pressed by the fixing roller 51 and the pressing roller 52 with the nip pressure while being fed by the fixing nip N. By doing so, the yellow, magenta, cyan and black toner images are fused and mixed so that a full-color image is fixed on the surface of the recording material P. The recording material P discharging from the fixing nip N is separated from the fixing roller 51 or the pressing roller 52 by a separation claw (unshown), And is relayed by the fixing and sheet discharging roller 56 and then is discharged from the fixing device F1.

The parting material applicator 53 applies the dimethyl silicone oil or the like as a parting material onto the surface of the fixing roller 51. The parting material applicator 53 applies silicone oil on the surface of the fixing roller 51 to prevent the toner from depositing on the surface of the fixing roller 51 when the recording material P passes through the fixing nip N.

A web type cleaning device 54 includes a heat resistive cleaning member in the form of a web which functions to clean the surface of the fixing roller 51. The cleaning device 55 of the web type includes a heat resistive cleaning member which cleans the surface of the pressing roller 52. The cleaning devices 54, 55 remove the toner offset to the surfaces of the fixing roller 51 and the pressing roller 52.

In order to fix the unfixed toner image, the fixing device F1 requires sufficient heat quantity and pressure so that the toner images are sufficiently fused to infiltrate into the recording material P. The toner image on the recording material P is heated up to approx. 110 and is separated from the fixing roller 51 with such a temperature, and is cooled down during the feeding of the recording material. As regards the viscoelastic property of the toner, the glass transition point temperature is approx. 55, and the fusing starting temperature is approx. 90, and therefore, the toner image is still soft immediately after the separation from the surface of the fixing roller. During the gradual cooling in the feeding operation, a fine unsmoothness is formed on the surface of the toner image in accordance with the unsmoothness of the surface of the recording material P, and therefore, the surface of the toner image becomes a light scattering surface.

For this reason, even if the surface property of the surface of the fixing roller 51 is raised in an attempt to increase the glossiness of the output image, the glossiness of the output image does not rise despite the surface property is enhanced beyond a certain level. Therefore, the glossiness of the surface of the ordinary electrophotographic prints finished by the fixing device F1 is at most 10-50%) (60°.

### <Glossiness Treating Device>

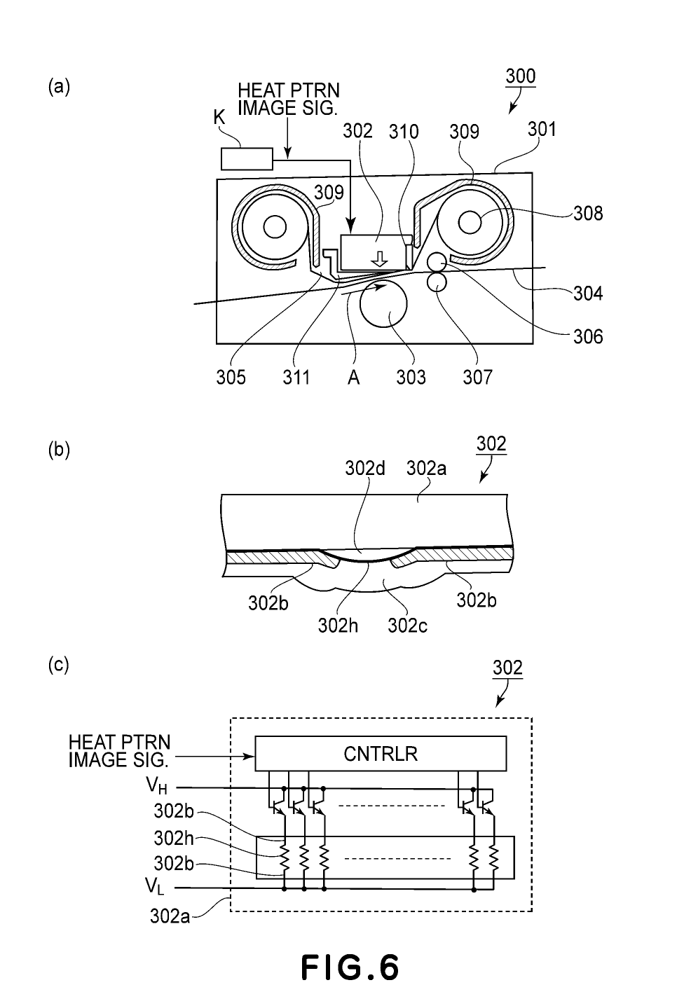

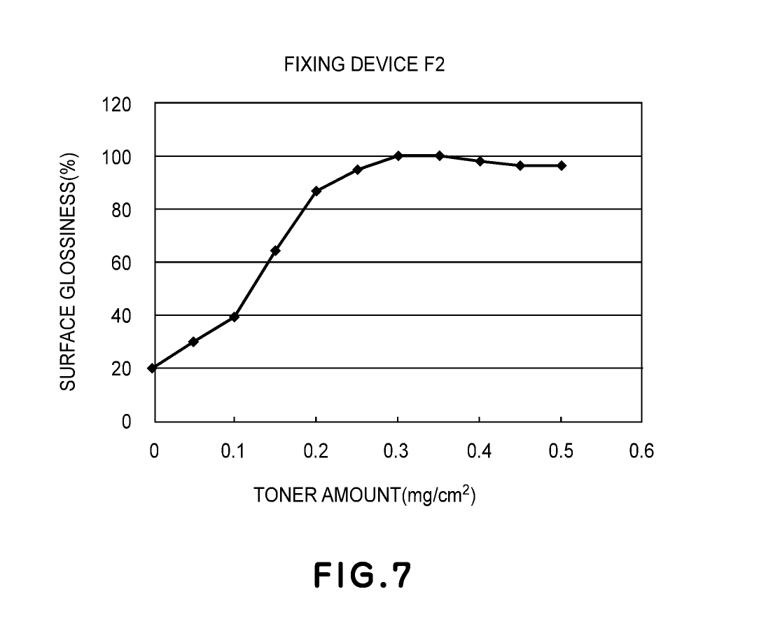

FIG. 6 is an illustration of the structures of a glossiness treating device. FIG. 7 shows a relation between an amount of toner and a glossiness after glossiness treatment. Japanese Patent Applications Nos. 2010-149183 and 2010-149184 assigned to the assignee of this application discloses a glossiness treating device using a film and a thermal head. In this embodiment, such a glossiness treating device is used as an optional device in an image forming system.

As shown in part (a) of FIG. 6, a glossiness treating device 300 which is an example of the image heating device is capable of providing a surface property which is different from that provided by the fixing device F1, by heating selectively a set area of the recording material on which the non-transparent toner image and the transparent toner image are formed.

A fixing film cassette 309 (film material supplying means) supplies the fixing film 305 (film material) having a target surface property. A gripping roller 306 and a pinch roller 307 (feeding means) feeds integrally the fixing film 305 and the recording material P having the fixed non-transparent toner image and transparent toner image, while the fixing film 305 is in contact with the image surface. The thermal head 302 heats the area through the fixing film 305 at a position where the fixing film 305 and the recording material P are pressed together.

The glossiness treating portion F2 of the glossiness treating device 300 is provided with a thermal head 302 for heating characters and images on the recording material with a pattern set in accordance with the glossiness treatment data. The thermal head 302 has a structure similar to the line type recording for an ordinary thermal print. The thermal head 302 is provided on a circuit board (bottom surface in the Figure) with a plurality of heat generating elements arranged in the direction perpendicular to the sheet of the drawing (sub-scan direction) at predetermined intervals. Opposed to the heat generating elements arranged in the line, there is provided a platen roller 303 for nipping the recording material P and the fixing film 305.

The platen roller 303 is rotatably supported at the opposite ends thereof. In addition, the platen roller 303 is supported to movably toward and away from the thermal head 302, at the opposite ends. The platen roller 303 is placed at such a position that the thermal head 302 is press-contacted thereto during the recording operation (printing operation). The face of the thermal head 302 is provided with a protecting member 311 for preventing contact between the fixing film 305 and the electrical parts such as thermister provided on the circuit board of the thermal head 302.

During the heating, the recording material P and the fixing film 305 are press-contacted by being nipped by the thermal head 302 and the platen roller 303. In this state, the heat generating elements of the thermal head 302 is actuated by which the toner image on the recording material P is fused, and the surface thereof follows the surface property of the fixing film 305. In the case of the line type thermal head 302, the image is heated along a line extending in the sub-scan direction by one heating actuation.

The recording material P is nipped by a gripping roller 306 and the pinch roller 307 therebetween, and during the heating operation, the recording material P is fed in the direction indicated by an arrow A by the rotation of the gripping roller 306. Simultaneously therewith, a winding-up mechanism is driven so that the fixing film 305 is wound up on a winding-up shaft 308 and is fed in the direction of the arrow A. In synchronism with the feeding of the recording material P and the fixing film 305 in the direction of the arrow A, the heat generating elements of the thermal head 302 are selectively and repeatedly actuated in accordance with the image information so that glossiness treatment data of one line are sequentially recorded.

Thereafter, the recording material P is fed toward the sheet discharge opening by feeding rollers 6, 7. On the other hand, the fixing film 305 is wound on the winding-up shaft 308 of the fixing film cassette 309. To accomplish this feeding path of the recording material P and the feeding path of the fixing film 305 are branched at a position downstream of the thermal head 302 with respect to the feeding direction. At the branching position, the recording sheet and the fixing film are peeled off each other.

As shown in part (b) of FIG. 6, the thermal head 302 includes a substrate 302a and a heat insulation layer and a heat generating element 302h for one line heating thereon, and the heat generating element 302h is covered by a glass layer 302c. The heat generating element 302h is supplied with electric power from an electrode 302b to generate heat so that the toner image on the recording material is heated through the fixing film sliding on the glass layer 302c.

As shown in part (c) of FIG. 6, the heat generating element 302h extending in the direction perpendicular to the feeding direction of the recording material is actuated in accordance with the heating pattern image signal. Among the number of pixels in one line, such ones as correspond to the area-to-be-heated of the heating pattern are actuated altogether to generate heat.

The fixing film 305 is a thin layer film of the resin material such as polyimide, PE or PET. In this embodiment, it is polyimide film having a thickness of 10 μm. In order to reduce the thermal capacity of the fixing film 305, it is preferable that it is thin as long as the handling thereof is impractically difficult.

In the glossiness treating device F2, the toner image is heated up to approx. 110 together with the fixing film 305 in order to melt the surface of the toner image. Thereafter, they are cooled down to the level around the glass transition point temperature while keeping the close contact with the fixing film 305, and then the fixing film 305 is peeled off the toner image. The toner image cooled down to about the glass transition point temperature it is substantially completely solidified reflecting the surface property of the fixing film 305 on the surface of the toner image. Therefore, the surface of the toner image increases with the surface property of the fixing film 305.

As shown in FIG. 7, by the glossiness treatment using the glossiness treating device F2, an electrophotographic print having a surface glossiness as high as 90-100%(60°), as compared with a print processed by the fixing device F1 which has a glossiness of 10-50% can be provided.

FIG. 7 shows the results when the image formation, fixing and glossiness treatment are carried out on the A2 size gloss coated paper having a basis weight of 150 g/m̂2 using only the transparent toner, but it has been confirmed that substantially the similar results are obtained when the recording material is plain paper. It has also been confirmed that substantially the same relation between the toner deposition amount and the glossiness with respect to the yellow, magenta, cyan and black toner, and that the difference in the glossiness after being processed by the glossiness treating device F2 depending on the color is not significant.

However, such a high glossiness is not provided on a surface of the recording material not carrying a full-color image toner image. Also, in the case that a total toner deposition amount of a full-color image it less than 0.3 mg/cm̂2, a visual glossiness is a significantly poor as compared with the case that the toner deposition amount is not less than 0.3 mg/cm̂2.

In view of this, according to Embodiment 1, for the surface of the recording material on which the total toner deposition of the full-color image amount is less than 0.3 mg/cm̂2, a corresponding amount of the transparent toner image (toner deposition amount) is formed to compensate for the shortage. By covering the non-toner area with the transparent toner image so that a high glossiness pattern is formed, even for the recording material having a surface which is not melted around the fixing temperature.

### Embodiment 1

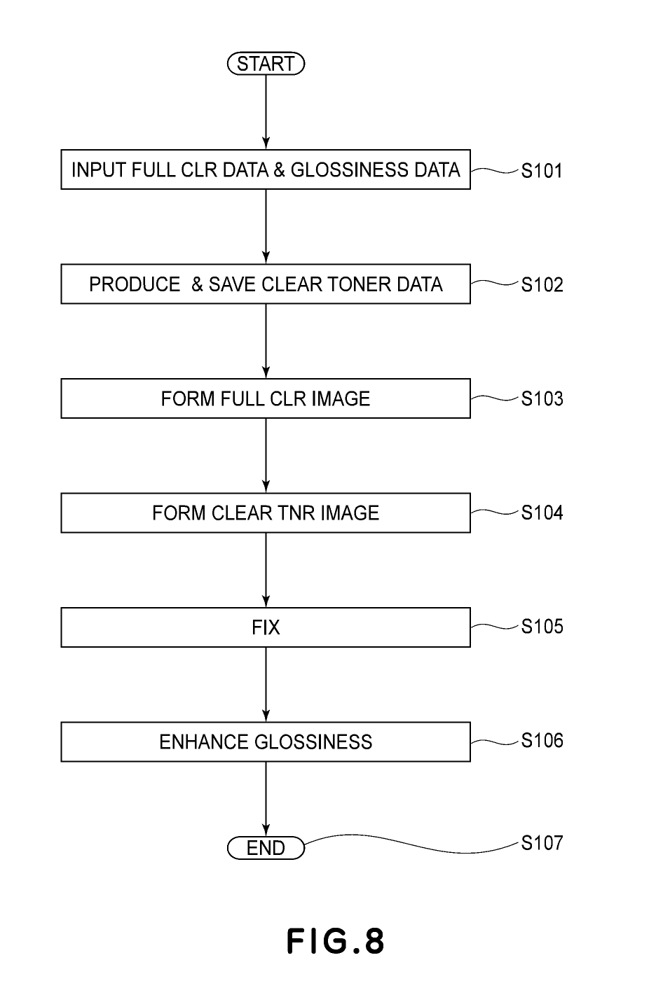

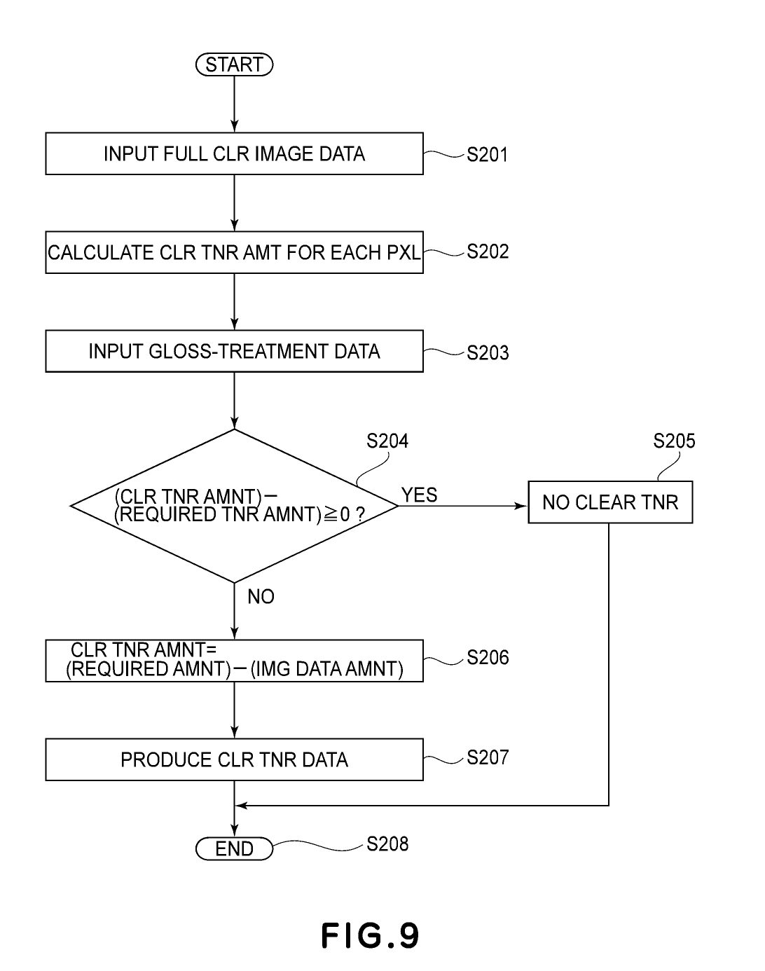

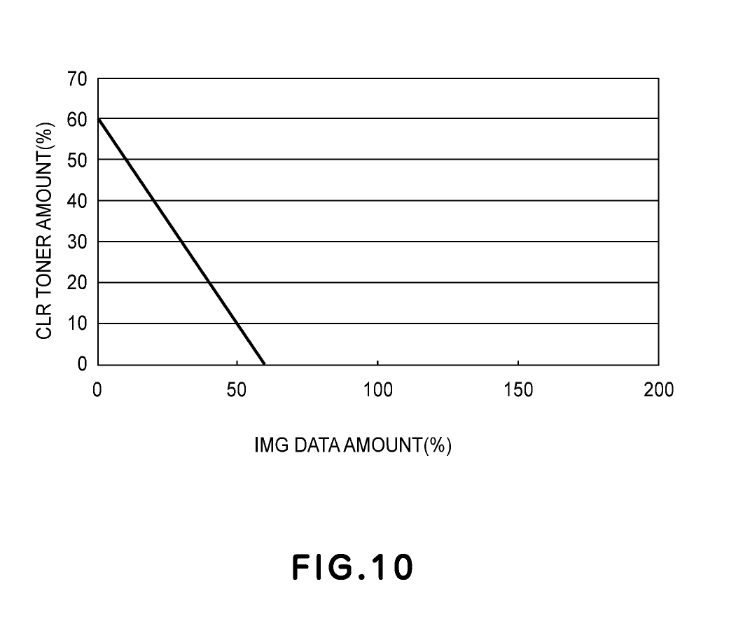

FIG. 8 is a flow chart of a glossiness treatment control according to Embodiment 1. FIG. 9 is a flow chart of transparent toner amount control. FIG. 10 is an illustration of transparent toner amount setting.

As shown in FIG. 1, the image forming stations Pa, Pb, Pc, Pd and the fixing device F1, which are an example of the non-transparent image forming means, form non-transparent toner images and fix them on the recording material. An image forming station Pe and a fixing device F1 (transparent image forming means) form and fix the transparent toner image on the recording material. The image forming stations Pa, Pb, Pc, Pd and the image forming station Pe transfer the non-transparent toner image and the transparent toner image onto the recording material P, and then fix them on the recording material substantially simultaneously by the fixing device F1.

The image forming station Pe forms and fixes the transparent toner image on an area (in the area-to-be-heated of the recording material prior to the heating by the glossiness treating device 300) not having an enough toner deposition amount for the desired surface property, so that the enough toner deposition amount is provided. The image forming station Pe forms the transparent toner image on the basis of image data of the non-transparent toner image and designation data for the area-to-be-heated so that a total toner deposition amount of the non-transparent toner image and the transparent toner image in area-to-be-heated of the image surface of the recording material P becomes uniform.

In Embodiment 1, the image forming apparatus 100 comprises the glossiness treating device F2 using a thermal head, in addition to the full-color image forming stations Pa, Pb, Pc, Pd and the image forming station Pe using the transparent toner.

As shown in FIG. 3 and FIG. 8, the controller K gains, in a first step, image information including information of an image forming area of the non-transparent toner image and heating area information for specifying the area-to-be-heated on the recording material. The controller K, in a second step, sets an image forming area of the transparent toner image which is in the area-to-be-heated and out of an image forming area of the non-transparent toner image. In the second step, the image forming area of the transparent toner image includes such an area in the area-to-be-heated that the toner deposition amount of the image forming area of the non-transparent toner image is less than a predetermined amount. The controller K, in a third step, sets an image formation amount of the transparent toner image such that the total toner deposition amount of the non-transparent toner image and the transparent toner image in the transparent toner image forming area set in the second step.

The user sends full-color image data (four color image data) and the image data indicative of an area to be made gloss. Y The image data indicative of the glossiness treatment portion is called glossiness treatment data. Therefore, the user sends the glossiness treatment data with the full-color image data to the image forming apparatus 100.

When the controller K receives the full-color image data and the glossiness treatment data (S101), the controller K produces transparent toner image data necessary to form the transparent toner image. The controller K compares the full-color image data and the glossiness treatment data to calculate a portion which is to be subjected to the glossiness treatment and which does not have the full-color image data. And, it produces, for the portion not having enough toner deposition amount for desired glossiness, the transparent toner image data to form a transparent toner image to provide an appropriate toner deposition amount. As for the generation of the transparent toner image data, the description will be made in detail, hereinafter.

The controller K controls the image forming stations Pa, Pb, Pc, Pd using the full-color image data so as to form full-color toner image (S103). The image formation is carried out by the full-color image forming stations Pa, Pb, Pc, Pd in accordance with the full-color image data. Subsequently, the controller K controls the image forming station Pe using the transparent toner image data to form the transparent toner image (S104).

The recording material P having the transferred full-color image and the transparent image been subjected to the fixing process of the fixing device F1 (S105). Then, the controller K controls the glossiness treating device F2 to effect the glossiness treatment (S106). The controller K operates the thermal head of the glossiness treating device F2 in synchronism with the glossiness treatment data. The toner image carried on the recording material P is heated and melted in accordance with the glossiness treatment data to stick on the fixing film partly to provide a smooth surface.

By this, the glossiness marking having a glossiness higher than that in the area therearound, in the area or pattern designated by the glossiness treatment data. After the transparent toner image is formed on the basis of the full-color image data and the glossiness treatment data, the glossiness treatment by the glossiness treating device F2 is carries out, by which the glossiness marking in accordance with the glossiness treatment data.

### <Production of the Transparent Toner Image Data>

The controller K divides the original full-color image data into C, M Y, K images, and calculates image data amounts for the respective color images in accordance with the density of the pixels. The image data amount is data amount per pixel of the color-separated image information and is expressed by percentage to the maximum image data amount (100%). The toner amount for each color is calculated in accordance with the 0-100% image data amount.

Here, the toner amount is a toner amount per pixel of the image to be formed on the recording material. The toner amount is also expressed by 0-100%. On the other hand, a weight of the toner per 1 cm̂2 is called toner deposition amount (mg/cm̂2).

The maximum density for a color occurs in the 100% toner amount of monochromatic image. The maximum density for each color is determined by the image design, the toner property, the fixing condition of the fixing device F1, the kind of the recording material P and so on. In Embodiment 1, the image forming condition is such that the process speed is 100 mm/sec, and the control temperatures (target temperatures) of the fixing roller 51 and the pressing roller 52 are 160. Under such image forming conditions, when the toner deposition amount is 0.5 mg/cm̂2 on A2 gloss coated paper having a basis weight of 150 g/m̂2 without is glossiness treatment by the glossiness treating device F2, the resulting density is 1.8 for each color. The toner deposition amount 0.5 mg/cm̂2 at this time is defined as the maximum toner deposition for a color.

The toner amount for each pixel is calculated for each color image data amount of the input image by image correction such as so-called gamma correction so as to balance the color tone. Thus, various colors are expressed by four colors overlaying with adjusted toner deposition amounts.

Theoretically, the maximum image data amount is 400% as a sum of C, M, Y and K data. However, in consideration of conditions to the toner amount which can be fixed by the fixing device, the image processing is carries out such that the maximum image data amount is 240%.

On the other hand, the glossiness treatment data are binary data indicative of application or non-application of the glossiness to each pixel. The transparent toner image is set not as a density, but as the toner deposition amount providing a desired glossiness after passing through the glossiness treating device F2.

As shown in FIG. 7, when the transparent toner image is subjected to the glossiness treatment of the glossiness treating device F2, the glossiness is 100% with the transparent toner deposition amount of not less than 0.3 mg/cm̂2. Therefore, the toner deposition amount of the transparent toner image on the blank of the recording material is set as 0.3 mg/cm̂2. As described hereinbefore, the toner deposition amount of 0.5 mg/cm̂2 corresponds to the toner amount of 100%, and therefore, image data amount of the toner deposition amount of 0.3 mg/cm̂2 is 60%. In Embodiment 1, the production of the transparent toner image data is carried out in accordance with the flow chart of FIG. 9.

As shown in FIG. 3 and FIG. 9, when the controller K receives the full-color image data (S201), it calculates the image data amount for each color toner for each pixel on the full-color image (S202).

When the controller K then receives the glossiness treatment data (S203), it compares the toner amount necessary for the glossiness treatment and the total toner amount for each color, with respect to the pixel to be subjected to the glossiness treatment. For the pixel (No, in S204) in which the amount of color toner is not enough, the transparent toner image data for the transparent toner image formation is produced (S206).

More particularly, when the image data amount of the portion to be subjected to the glossiness treatment is not satisfied the following inequality, the transparent toner image is formed to partially compensate the toner deposition amount.

(image data amount of full-color image data)−(toner amount required for glossiness treatment)0.

However, no transparent toner image is formed for the pixel (Yes in S204) in which the color toner amount is sufficient or the pixel which is not to be subjected to the glossiness treatment (S205). For example, in a pixel in which Y=0%, M=100%, C=100%, K=0%, the image data amount is 200%. The necessary toner amount for the glossiness treatment is 60% for this pixel. Therefore, in this example, 200−60=140, and therefore, it is not necessary to overlay the transparent toner image, and the transparent toner image data is 0.

As shown in FIG. 10, in the case that (the image data of the full-color image data)<60%, the transparent toner image has to be overlaid, and therefore, the transparent toner image data is calculated by the following: FIG. 10 shows the graph representing the formula.

Transparent toner amount=(toner amount necessary for the glossiness treatment)−(image data amount)

Such a discrimination and calculation is carried out for each of the pixels to obtain the transparent toner image data for the image. Thus, transparent toner image data for the pixels are set for the entire image, (S207) and the preparation for the image formation is completed.

In the image forming apparatus shown in 1, the control of Embodiment 1 was carried out. The partial glossiness treatment was carried out on A2 gloss coated paper having a basis weight of 150 g/m̂2, and the results were satisfactory image formation having a sufficient glossiness.

Thus, there is provided an image forming apparatus 100 with which an output image having glossy letters and/or patterns can be provided even on a recording material such as plain paper and coated paper which have surfaces which do not melt up the temperature around the fixing temperature.

### Embodiment 2

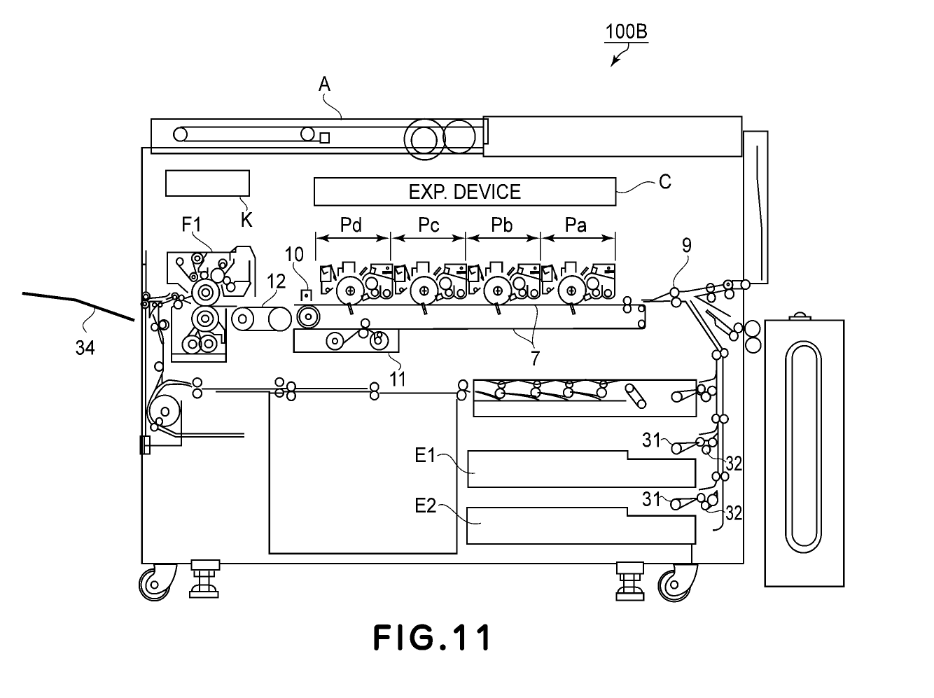

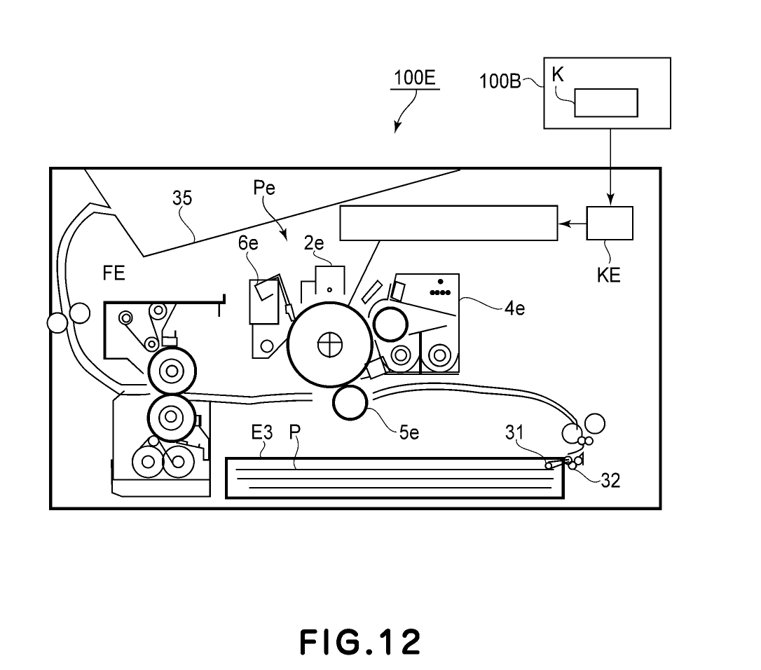

FIG. 11 is an illustration of the structures of a full-color image forming device according to Embodiment 2. FIG. 12 is an illustration of the structures of a transparent image forming device. FIG. 6 is an illustration of the structures of a glossiness treating device. In Embodiment 2, a full-color image forming device, a transparent image forming device and a glossiness treating device are independent from each other.

As shown in FIG. 11, the image forming apparatus 100B is a full color printer of a tandem type recording material feeding system in which yellow, magenta, cyan and black image forming stations Pa, Pb, Pc, Pd are arranged along a travel of the recording material feeding belt 7. The image forming apparatus 100B of FIG. 11 is the same as the image forming apparatus 100 of FIG. 1 with the exception that the image forming apparatus 100B is not provided with the image forming station Pe for forming the transparent toner image. In the description of this embodiment, the same reference numerals as in Embodiment 1 (FIGS. 1 and 2) are assigned to the elements having the corresponding functions in this embodiment (FIG. 11), and the detailed description thereof is omitted for simplicity.

In the image forming apparatus 100B, the recording material P supplied from a first recording material cassette E1 or a second recording material cassette E2 is carried on a, and receives a toner image of each color in the image forming stations Pa, Pb, Pc, Pd. The recording material P carrying the full-color toner image (not yet fixed) is removed from the recording material feeding belt 7 by curvature change and is introduced into the fixing device F1, where it is subjected to the heat pressing, so that the full-color image is fixed on the surface of the recording material P. The recording material P carrying of the fixed full-color image is discharged from the image forming apparatus 100B and is stacked on the discharging tray 34.

As shown in FIG. 12, the transparent image forming device 100E forms a transparent toner image on the photosensitive drum 1e and transfers it onto the recording material P supplied from a recording material cassette E3. The recording material P carrying the transparent toner image (not yet fixed) is introduced into a fixing device FE, where it is subjected to the heat pressing so that the transparent image is fixed on the surface of the recording material P. As for the formation and transfer of the transparent toner image, the description in conjunction with FIGS. 1, 2 applies here, and therefore, the same reference numerals as in FIGS. 1 and 2 are assigned to the elements having the corresponding functions in FIG. 12, and the detailed descriptions thereof are omitted for simplicity.

The image forming apparatus 100B of FIG. 11 and the transparent image forming device 100E of FIG. 12 are provided with respective casings, and is apparatuses are independent from each other. However, the transparent image forming device 100E is connected with a controller K which is similar to that of Embodiment 1, and is controlled, in the transparent image formation, on the basis of the image data of the non-transparent toner image and the designation data of area-to-be-heated.

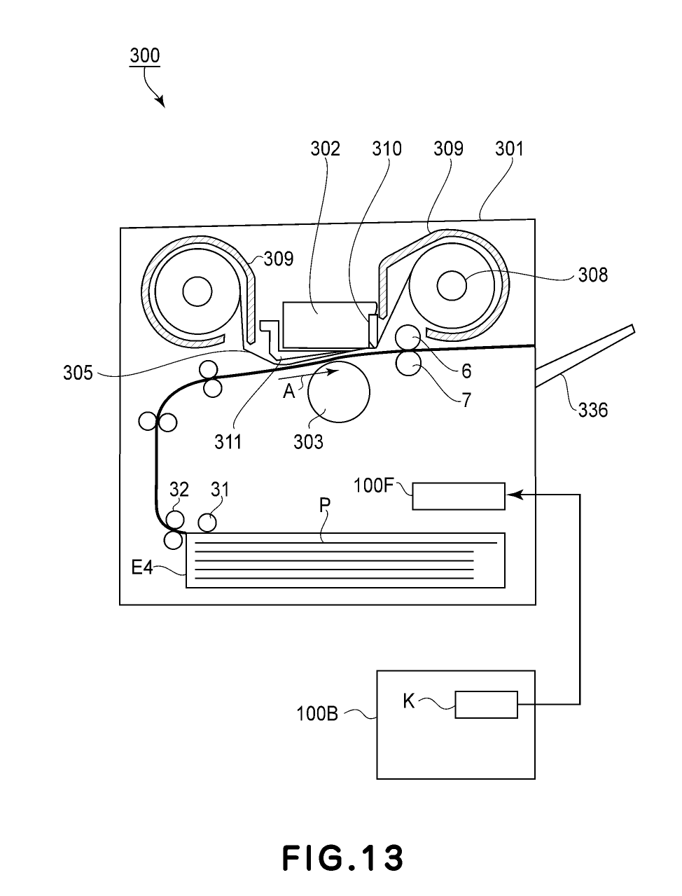

As shown in FIG. 13, the glossiness treating device 300 effects the glossiness treating operation on the surface of the recording material P supplied from the recording material cassette E4. The recording material P carrying the fixed image is heated by the thermal head 302 in the form of a pattern, in the states that the fixing film 305 is overlaid thereon, by which only the heated zone (pattern) is melted and deposited on the fixing film 305 so that the glossy surface is transferred. The glossiness treatment in this embodiment is the same as that described in conjunction with FIG. 6, and therefore, detailed description is omitted by assigning the same reference numerals as in FIGS. 6, 1 to the elements having to the corresponding functions in FIG. 13.

As shown in FIG. 12, in Embodiment 2, the image forming apparatus 100B forms the full-color image or the monochromatic image on the recording material P, and then the outputted recording material P is placed on the transparent image forming device 100E, an additional printing is effected on the recording material with the transparent toner. In the transparent image forming device 100E, the transparent image is formed on the area (pattern portion) which corresponds to white background portion of the image and which is free of transferred toner image.

The recording material P carrying the full-color image is placed in the sheet feeder of the transparent image forming device 100E by the user. An operating portion of the transparent image forming device 100E is provided with a displayed portion on which place recording material carrying image in recording material cassette E3.

At this time, the glossiness treatment data has been supplied to the controller K, and the transparent toner image data have been produced. When the user depresses a start key of the operating portion of the transparent image forming device 100E, a transparent toner image is formed in accordance with the produced data.

As shown in FIG. 13, thereafter, the recording material having been subjected to the transparent toner image formation is placed in the sheet feeder of the glossiness treating device 300. The recording material P carrying the transparent image is placed in the glossiness treating device 300 to provide high glossiness in accordance with partial heating corresponding to the heating pattern. By such image formation and image surface treatment, a high glossiness image pattern can be provided even on a recording material P having a surface which is not melted around the fixing temperature. Such a system is provided according to this embodiment.

As described in the foregoing, according to Embodiment 2, the image forming stations Pa, Pb, Pc, Pd, the image forming station Pe and the glossiness treating device 300 are provided with respective casings. A controller K which is a controller provided on the casing of the image forming stations Pa, Pb, Pc, Pd, controls the image forming station Pe and the glossiness treating device 300 on the basis of the received image data of the image formation job.

In Embodiment 2, an image including a partially-glossy-image is formed on the recording material on the basis of the image data of the non-transparent toner image and the designation data of the glossy area through a method including the following steps.

In a first step, an ordinary image forming apparatus is operated so that a non-transparent toner image formed on the basis of the full-color image data is transferred and fixed on the recording material.

In a second step, a transparent toner image formed on the basis of the image data and the designation data of the glossy area is transferred and fixed on the white background portion of the recording material. The transparent toner image is formed only on the area which does not correspond to the image data and which corresponds to the glossy area designation data, that is, only the area which does not have the non-transparent toner image within the area to be subjected to the glossiness treatment. Or, it is formed only on an area which is within an area to be subjected to the glossiness treatment and which does not have the non-transparent toner image, and an area in which the toner deposition amount of the non-transparent toner image is not enough to provide a glossy surface.

In a third step, the thermal head 302 is operated on the basis of the designation data of the glossy area, and the glossiness area is brought into melting contact with the fixing film 305, and the recording material is peeled off the fixing film 305 after cooling and solidification.

On the contrary, however, an image pattern may be first formed with the transparent toner on the blank paper using the transparent image forming device 100E, and then the full-color image may be formed using the image forming apparatus 100B.

### Embodiment 3

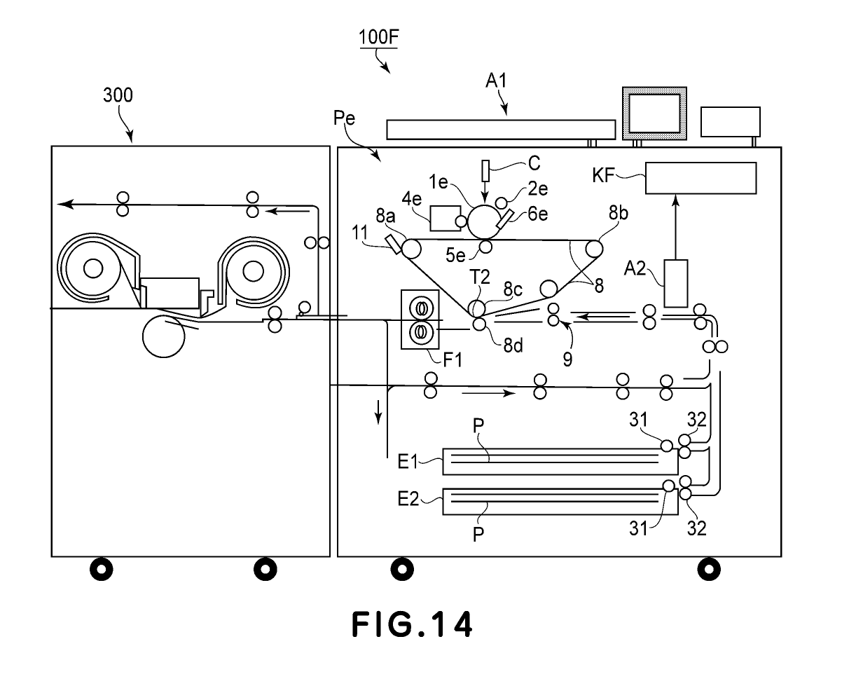

FIG. 14 is an illustration of the structures of an image surface treatment device according to Embodiment 3 An image surface treatment system of Embodiment 3 comprises an independent transparent image forming device 100F and a glossiness treating device 300 of FIG. 13 connected to the transparent image forming device 100F. In Embodiment 3, the image data of the image formation job is not supplied to the transparent image forming device 100F, and therefore, the image of the recording material is read by an image reading device, and the image data are generated by the image reading device. Therefore, onto the recording material P on which a monochromatic image and/or a full-color image has already been formed by the image forming apparatus 100B, a partial transparent toner image corresponding to the heating pattern is transferred, and the transparent toner image is fixed, and then partial glossiness treatment is carried out using the thermal head and the fixing film.

As shown in FIG. 14, the transparent image forming device 100F transfers the transparent toner image formed by the image forming station Pe onto the intermediary transfer belt 8, and with rotation of the intermediary transfer belt 8, convey it to a secondary transfer portion T2 where the transparent toner image is secondary transferred onto the recording material P. The recording material P having the transferred transparent toner image is subjected to the heat pressing by the fixing device F1 so that the transparent toner image is fixed on the surface of the recording material P.

The transparent image forming device 100F reads the image on the recording material P by an original reading station A1 or an original-feeding reading portion A2 in order to the transparent image corresponding to the heating pattern on the white background portion of the recording material P. The controller KF reads the recording material P on which the partial glossiness treatment is to be effected to gain the area of the toner image, and produces image data of the transparent toner image. The controller KF forms the transparent toner image on the white background portion of the recording material which is not covered by the image in the area-to-be-heated indicated by the heating pattern.

The calculation of the toner deposition amount from the image density data read by the original reading station A1 is the same as in the control when the image is printed by the image forming apparatus 100 of FIG. 1.

As in the description referring to FIG. 1, the original reading station A1 optically scans the original placed on the original supporting platen glass to effect the color-separation photoelectric reading of the original image. A color original on which the partially-glossy-image is to be formed is placed facedown on the original supporting platen glass, and is covered by an original cover.

A moving optical system moves along a lower surface of the original supporting platen glass to optically scan the image surface of the original on the original supporting platen glass. The original scanning light is imaged on a photoelectric conversion element to read the original in color-separated manner (RGB).

On the other hand, original-feeding reading portion A2 detects the toner on the recording material using a linear optical sensor (CCD array) having a resolution not less than that of the thermal head of the glossiness treating device 300. The image of the recording material P fed from the recording material cassette E1, E2 is read by the original-feeding reading portion A2 in color-separated manner into RGB data.

The RGB signals thus obtained are supplied to the image processor and are converted to C, M, Y, K image data. The controller KF calculates the image data of the transparent toner image on the basis of the image data and the glossiness treatment data. The calculation similar to the control in accordance with the flow charts of FIGS. 8, 9 on the basis of the glossiness treatment data and the image data is carries out to obtain the transparent toner amount to be applied so that the toner deposition amount of the corresponding portion is not less than the predetermined amount. The transparent toner image is formed on the image surface of the recording material in accordance with the image data of the transparent toner image, and then the glossiness treatment is effected only on the area selected by the glossiness treatment data, using the glossiness treating device 300.

As described in the foregoing, in the image surface treatment device of Embodiment 3, the recording material having the fixed toner image is subjected to the heating to provide the image surface with a surface property. The transparent image forming device 100F forms the transparent toner image with a necessary toner deposition amount on the area having not enough toner deposition amount for the intended surface property in the area-to-be-heated, before the heating treatment of the glossiness treating device 300.

The glossiness treating device 300 heats the area-to-be-heated which can be selectively set to provide a surface property different form that provided by the fixing process of the fixing device F1.

The original reading station A1 and the original-feeding reading portion A2 which are the image reading means read the image on the recording material on which the image has been fixed. The transparent image forming device 100F forms the transparent toner image on the area not having the toner image within the area-to-be-heated on the basis of the result of the reading of the original reading station A1 or the original-feeding reading portion A2.

In this manner, in an image forming apparatus comprising an image forming station for forming the toner image and a glossiness treating device with which the heating area is variable, the toner image is formed on the basis of the glossiness treatment data indicative of the area to be supplied to the glossiness treatment. The high glossiness image can be provided even on a recording material having a surface not melting around the fixing temperature, by the transparent image formation and glossiness treatment described in the foregoing.

While the invention has been described with reference to the structures disclosed herein, it is not confined to the details set forth, and this application is intended to cover such modification or changes as may come within the purposes of the improvements or the scope of the following claims.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 093900/2011 filed Apr. 20, 2011 which is hereby incorporated by reference.

What is claimed is:

1. An image forming apparatus comprising:
a non-transparent image forming device for forming a non-transparent toner image on a sheet;
a transparent image forming device for forming a transparent toner image on a sheet;
a partial heating device for heating an area, designated by a user, of the sheet having a toner image; and
a control device for controlling said transparent image forming device such that the transparent toner is overlaid on an area where an amount, per unit area, of the non-transparent toner image formed in the area designated by the user is 0 or less than a predetermined amount.

2. An apparatus according to claim 1, wherein said partial heating device includes a film contactable to a sheet having the toner image, and a thermal head contactable to a surface of the film opposite the surface contacting the sheet, said thermal head being effective to selectively heat the sheet through the film in the area designated by the user.

3. An apparatus according to claim 1, wherein the amount of the toner formed by transparent image forming device in an area designated by the user is such that a sum of the amounts of the transparent toner and the non-transparent toner exceeds the predetermined amount.

4. An apparatus according to claim 1, further comprising a heating device, provided upstream of said partial heating device with respect to a feeding direction of the sheet, for heating uniformly the toner image formed on the sheet.
